(19) United States
(12) Patent Application Publication
(10) Pub. No.: US 2026/0158804 A1
(43) Pub. Date: Jun. 11, 2026

(54) MEDIUM CONVEYANCE APPARATUS AND LIQUID EJECTION APPARATUS

(71) Applicant: SEIKO EPSON CORPORATION, TOKYO (JP)

(72) Inventors: Seiji MIYAZAWA, MATSUMOTO-SHI (JP); Jun YODA, HINO-SHI (JP)

(21) Appl. No.: 19/409,850

(22) Filed: Dec. 5, 2025

(30) Foreign Application Priority Data
Dec. 5, 2024 (JP) 2024-211974

(51) Int. Cl. B41J 13/10; B41J 3/60; B41J 29/13

(52) U.S. Cl. CPC B41J 13/103; B41J 3/60; B41J 29/13

(57) ABSTRACT

A medium conveyance apparatus includes an apparatus main body, a medium housing cassette configured to be able to be pulled out with respect to the apparatus main body, a conveyance unit including a part of a conveyance path for conveying the medium housed in the medium housing cassette, a support tray provided integrally with the conveyance unit and capable of supporting the medium, and a cover that can be opened and closed and is provided to be capable of covering an opening portion, wherein the cover takes a first posture of covering the opening portion, a second posture in which the medium can be fed from the support tray, and a third posture in which the conveyance unit is attachable to and detachable from the apparatus main body.

The present application is based on, and claims priority from JP Application Serial Number 2024-211974, filed Dec. 5, 2024, the disclosure of which is hereby incorporated by reference herein in its entirety.

### BACKGROUND

### 1. Technical Field

The present disclosure relates to a medium conveyance apparatus and a liquid ejection apparatus.

### 2. Related Art

In the past, various medium conveyance apparatuses have been used in liquid ejection apparatuses and the like. In these apparatuses, some medium conveyance apparatuses have a configuration in which a medium conveyance unit is detachable from an apparatus main body. For example, JP-A-2018-134854 discloses a configuration in which a conveyance unit including a medium support portion disposed at a back surface of a recording apparatus is detachably attached to the recording apparatus. In addition, as a medium conveyance apparatus, a configuration in which an opening portion provided to an apparatus main body is covered with a cover is also disclosed. By covering the opening portion provided to the apparatus main body with the cover, it is possible to suppress entry of foreign matter from the opening portion. For example, JP-A-2010-78687 discloses a configuration in which a process cartridge disposed inside an apparatus main body can be replaced by opening a rotatable front cover by 90 degrees with respect to an opening portion.

JP-A-2018-134854 and JP-A-2010-78687 are examples of the related art.

However, in the related-art configuration in which the conveyance unit is detachably attached to the apparatus main body, workability in operations may be poor in some cases when the opening portion is covered with the cover. For example, when a front cover in JP-A-2010-78687 is adopted in the recording apparatus in JP-A-2018-134854, the front cover is always opened by 90 degrees when the conveyance unit is attached to and detached from the apparatus main body, and it is difficult to access the cassette in a state where the front cover is opened when, for example, both manual feeding of a medium and feeding of the medium from the cassette on which the medium is placed are used. Therefore, it is desired to improve the workability of the operations in such a configuration in which the conveyance unit is detachably attached to the apparatus main body.

### SUMMARY

A medium conveyance apparatus according to the present disclosure for solving the problems described above includes an apparatus main body, a medium housing cassette configured to be pulled out in a pull-out direction with respect to the apparatus main body, a conveyance unit including a part of a conveyance path through which a medium housed in the medium housing cassette is conveyed, a support tray provided integrally with the conveyance unit and configured to support media, and a cover provided so as to cover an opening portion disposed downstream in the pull-out direction of the conveyance unit in the apparatus main body, and configured to be opened and closed setting a direction crossing the pull-out direction as an extending direction of a pivot shaft, wherein the cover takes a first posture of covering the opening portion, a second posture in which a rotation tip at an opposite side to the pivot shaft is located more downstream in the pull-out direction than in the first posture and in which feeding of the medium from the support tray is enabled, and a third posture in which the rotation tip is located more downstream in the pull-out direction than in the second posture and in which the conveyance unit is attachable to and detachable from the apparatus main body.

### BRIEF DESCRIPTION OF THE DRAWINGS

FIG. 1 is a perspective view of a liquid ejection apparatus according to an embodiment of the present disclosure, and is a diagram showing a state in which a front cover is set in a first posture.

FIG. 2 is a perspective view of the liquid ejection apparatus in FIG. 1, and is a diagram showing a state in which the front cover is set in a second posture.

FIG. 3 is a perspective view of the liquid ejection apparatus in FIG. 1, and is a diagram showing a state in which a support tray is set to a medium support position from the state in FIG. 2.

FIG. 4 is a perspective view of the liquid ejection apparatus in FIG. 1, and is a diagram showing a state in which the front cover is set in a third posture.

FIG. 5 is a perspective view of the liquid ejection apparatus in FIG. 1, and is a diagram showing a state in which a flipping path unit is pulled out from the state in FIG. 4.

FIG. 6 is a schematic internal configuration diagram of the liquid ejection apparatus in FIG. 1 corresponding to the state in FIG. 3.

FIG. 7 is a perspective view of the liquid ejection apparatus in FIG. 1, and is a diagram showing a state in which the flipping path unit is further pulled out from the state in FIG. 5 to be detached.

FIG. 8 is a perspective view of the liquid ejection apparatus in FIG. 1, and is a diagram illustrating a state in which the front cover is set in the second posture from the state in FIG. 7 in which the flipping path unit is detached.

FIG. 9 is a diagram illustrating the flipping path unit of the liquid ejection apparatus in FIG. 1.

FIG. 10 is a perspective view showing the periphery of a posture maintaining section of the front cover of the liquid ejection apparatus in FIG. 1.

FIG. 11 is a perspective cross-sectional view showing the periphery of the posture maintaining section of the front cover of the liquid ejection apparatus in FIG. 1 viewed from a different angle from that in FIG. 10.

FIG. 12 is a perspective view showing the periphery of a biasing portion of the front cover of the liquid ejection apparatus in FIG. 1.

### DESCRIPTION OF EMBODIMENTS

The present disclosure will schematically be described below.

A medium conveyance apparatus according to a first aspect of the present disclosure includes an apparatus main body, a medium housing cassette configured to be pulled out in a pull-out direction with respect to the apparatus main body, a conveyance unit including a part of a conveyance path through which a medium housed in the medium housing cassette is conveyed, a support tray provided integrally with the conveyance unit and configured to support media, and a cover provided so as to cover an opening portion disposed downstream in the pull-out direction of the conveyance unit in the apparatus main body, and configured to be opened and closed setting a direction crossing the pull-out direction as an extending direction of a pivot shaft, wherein the cover takes a first posture of covering the opening portion, a second posture in which a rotation tip at an opposite side to the pivot shaft is located more downstream in the pull-out direction than in the first posture and in which feeding of the medium from the support tray is enabled, and a third posture in which the rotation tip is located more downstream in the pull-out direction than in the second posture and in which the conveyance unit is attachable to and detachable from the apparatus main body.

According to the present aspect, the cover takes the first posture of covering the opening portion, the second posture in which the rotation tip at the opposite side to the pivot shaft is located more downstream in the pull-out direction than in the first posture and the feeding of the medium from the support tray is enabled, and the third posture in which the rotation tip is located more downstream in the pull-out direction than in the second posture and the conveyance unit is attachable to and detachable from the apparatus main body. That is, the cover can take the second posture in which a degree of opening takes a value between those in the first posture and the third posture in addition to the first posture of covering the opening portion and the third posture in which the conveyance unit can be attached to and detached from the apparatus main body. Therefore, the degree of opening of the cover can be variously changed in accordance with the content of the operation, and the workability of each of the operations can be improved.

A medium conveyance apparatus according to a second aspect of the present disclosure is the medium conveyance apparatus according to the first aspect, wherein the conveyance unit is a flipping path unit forming at least a part of a flipping path configured to flip the medium in the conveyance path.

According to the present aspect, the conveyance unit is the flipping path unit forming at least a part of the flipping path that flips the medium. By adopting such a configuration, for example, when a jam or the like of the medium occurs in the flipping path and so on, it is possible to easily remove the medium in which the jam occurs.

A medium conveyance apparatus according to a third aspect of the present disclosure is the medium conveyance apparatus according to the first aspect or the second aspect, wherein the conveyance unit includes a mounting portion on which the medium supported by the support tray is mounted, and a hopper section configured to switch an inclination angle of the mounting portion viewed from a direction in which the pivot shaft extends.

According to the present aspect, the conveyance unit includes the mounting portion on which the medium supported by the support tray is mounted, and the hopper section capable of switching the inclination angle of the mounting portion viewed from the direction in which the pivot shaft extends. By adopting such a configuration, it is possible to suitably convey the medium supported by the support tray.

A medium conveyance apparatus according to a fourth aspect of the present disclosure is the medium conveyance apparatus according to any one of the first to third aspects, wherein the conveyance unit includes a separation roller configured to separate the media supported by the support tray.

According to the present aspect, the conveyance unit includes the separation roller configured to separate the media supported by the support tray. By adopting such a configuration, it is possible to convey the medium supported by the support tray while suppressing occurrence of duplex feed or the like.

A medium conveyance apparatus according to a fifth aspect of the present disclosure is the medium conveyance apparatus according to any one of the first to fourth aspects, wherein the conveyance unit includes a supply roller configured to supply the medium supported by the support tray.

According to the present aspect, the conveyance unit includes the supply roller configured to supply the medium supported by the support tray. By adopting such a configuration, it is possible to suitably convey the medium supported by the support tray.

A medium conveyance apparatus according to a sixth aspect of the present disclosure is the medium conveyance apparatus according to any one of the first to fifth aspects, further including a posture maintaining section of the cover, the posture maintaining section including a protrusion provided to one of the cover and the opening portion, and a hole provided to another of the cover and the opening portion and configured to be engaged with the protrusion, wherein the posture maintaining section is configured to maintain the cover in at least three postures of the first posture, the second posture, and the third posture by including at least one of three protrusions each identical to the protrusion and three holes each identical to the hole.

According to the present aspect, the posture maintaining section is configured to be able to maintain the cover in at least three postures of the first posture, the second posture, and the third posture by having at least one of three protrusions and three holes. By adopting such a configuration, the cover can be maintained in at least three postures of the first posture, the second posture, and the third posture with a simple device configuration.

A medium conveyance apparatus according to a seventh aspect of the present disclosure is the medium conveyance apparatus according to any one of the first to sixth aspects, further including a biasing portion configured to bias the cover in an opposite direction to a rotation direction in which the cover rotates by gravity.

According to the present aspect, the biasing portion configured to bias the cover in the opposite direction to the rotation direction in which the cover rotates by gravity is provided. By adopting such a configuration, it is possible to suitably rotate the cover in both of rotating the cover in the direction in which the cover rotates by gravity and rotating the cover in the opposite direction to the rotation direction in which the cover rotates by gravity.

A medium conveyance apparatus according to an eighth aspect of the present disclosure is the medium conveyance apparatus according to any one of the first to seventh aspects, further including a support portion configured to support the conveyance unit with a support surface in the apparatus main body, wherein in the third posture, a posture of the cover is maintained without a step from the support surface.

According to the present aspect, in the third posture, the posture of the cover is maintained without a step from the support surface of the support portion. By adopting such a configuration, the conveyance unit can be smoothly attached to and detached from the apparatus main body.

A medium conveyance apparatus according to a ninth aspect of the present disclosure is the medium conveyance apparatus according to any one of the first to eighth aspects, further including an operating portion configured to be operated when the conveyance unit is attached to and detached from the apparatus main body, a through hole provided to the support tray and configured to enable access to the operating portion, and a crossing-direction cover portion provided to the cover and configured to cover a part of the apparatus main body in the pull-out direction, a direction in which the pivot shaft extends, and a crossing-direction crossing the pull-out direction and the direction in which the pivot shaft extends when the cover is in the first posture, wherein the crossing-direction cover portion is disposed at a position not overlapping the through hole when viewed from a direction along the pull-out direction when the cover is in the third posture.

According to the present aspect, the crossing-direction cover portion is further provided, and the crossing-direction cover portion is disposed at a position that does not overlap the through hole when viewed from the direction along the pull-out direction when the cover is in the third posture. By adopting such a configuration, the opening portion can be particularly suitably covered, the access to the operating portion is not hindered, and further, the conveyance unit can be prevented from being pulled out more than necessary to be dropped.

A liquid ejection apparatus according to a tenth aspect of the present disclosure includes a liquid ejection unit configured to eject a liquid, and the medium conveyance apparatus according to any one of the first to ninth aspects.

According to the present aspect, it is possible to improve workability of each operation in the liquid ejection apparatus capable of forming an image and so on by ejecting the liquid onto the medium.

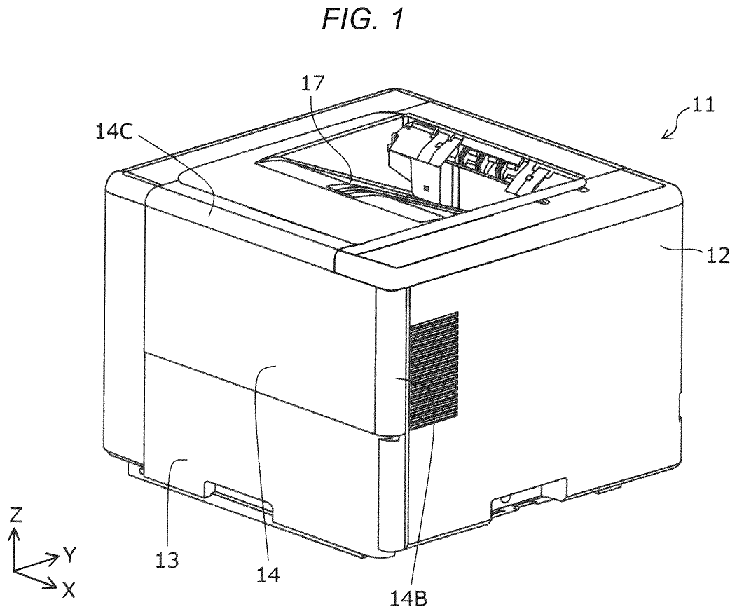

The present disclosure will specifically be described below. First, an outline of a recording apparatus 11 which is a liquid ejection apparatus including a medium conveyance apparatus according to an embodiment of the present disclosure will be described with reference to FIGS. 1 to 6. In the X-Y-Z coordinate system shown in the drawings, an X-axis direction is a lateral direction, that is, a width direction of the apparatus, a Y-axis direction is a frontward direction (front direction) and a backward direction of the apparatus, and a Z-axis direction is a height direction and a gravity direction of the apparatus. Note that a direction in which a medium M is conveyed is referred to as “downstream”, and a direction opposite thereto is referred to as “upstream”. Further, in the drawings, some of component members are omitted or simplified in some cases in order to facilitate understanding of an internal configuration and so on.

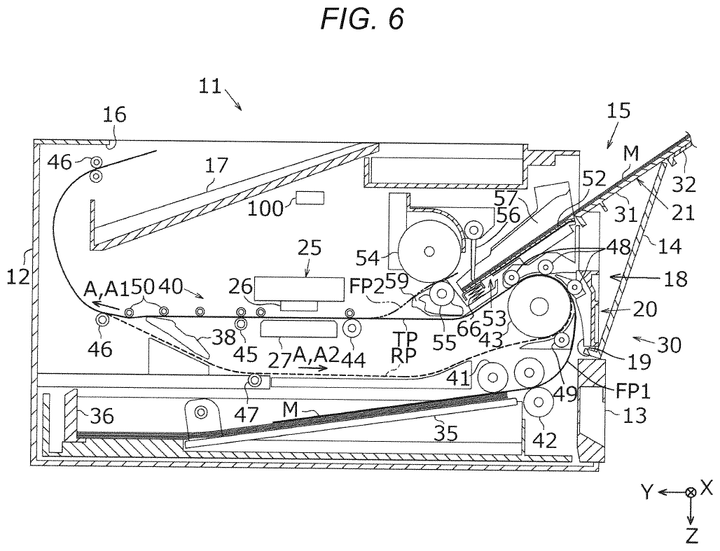

The recording apparatus 11 is a device that performs recording on the medium M. As illustrated in FIGS. 1 to 6, the recording apparatus 11 includes an apparatus main body 12. As illustrated in FIG. 6 and so on, the recording apparatus 11 includes a medium housing cassette 13, a front cover 14, a medium supply unit 15, and a stacker 17. The medium housing cassette 13 and the medium supply unit 15 are supply sources of the medium M. The recording apparatus 11 performs recording on the medium M supplied from the medium housing cassette 13 or the medium supply unit 15. The medium M on which recording has been performed is discharged from a discharge port 16 and is then stacked on the stacker 17. The medium supply unit 15 includes a support tray 21 that can support the medium M. The support tray 21 is housed inside the front cover 14.

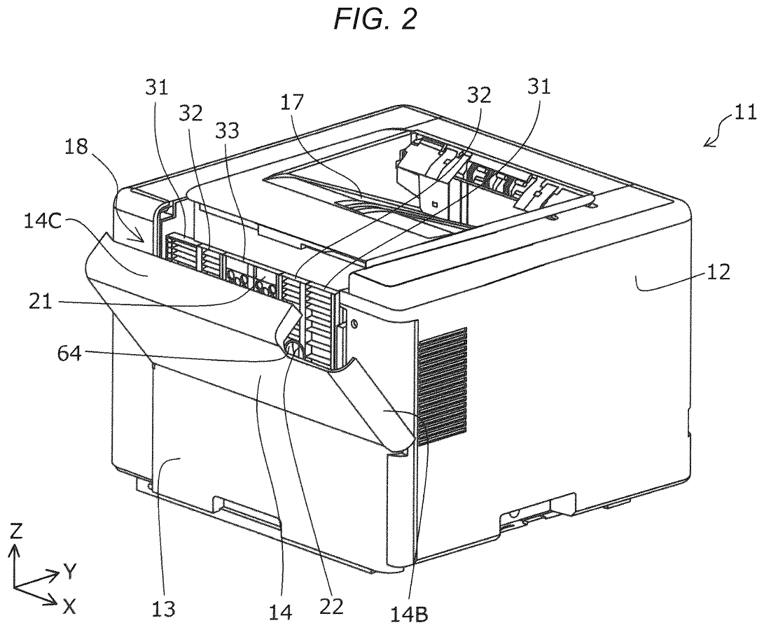

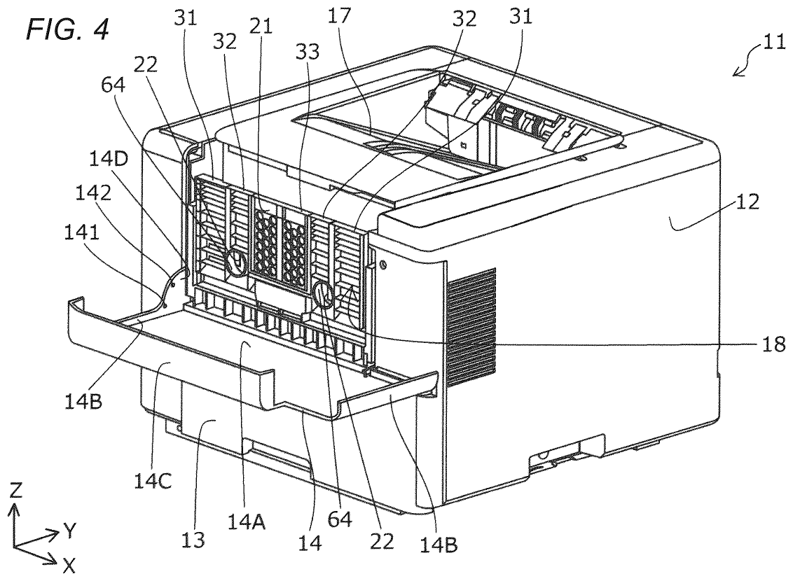

The front cover 14 is rotatable about a pivot shaft 19 extending in the X-axis direction and is provided to a front surface of the apparatus main body 12. As illustrated in FIG. 1, the front cover 14 covers, from the front side, the support tray 21 in a retracted state. The front cover 14 is disposed above the medium housing cassette 13. The recording apparatus 11 includes a flipping path unit 20. In a state where the front cover 14 of the recording apparatus 11 is opened, the flipping path unit 20 is exposed. The flipping path unit 20 is mounted in an opening portion 18 disposed in a front portion of the apparatus main body 12. The flipping path unit 20 includes the support tray 21. As illustrated in FIGS. 2 and 4, the support tray 21 is exposed by setting the front cover 14 to an open state.

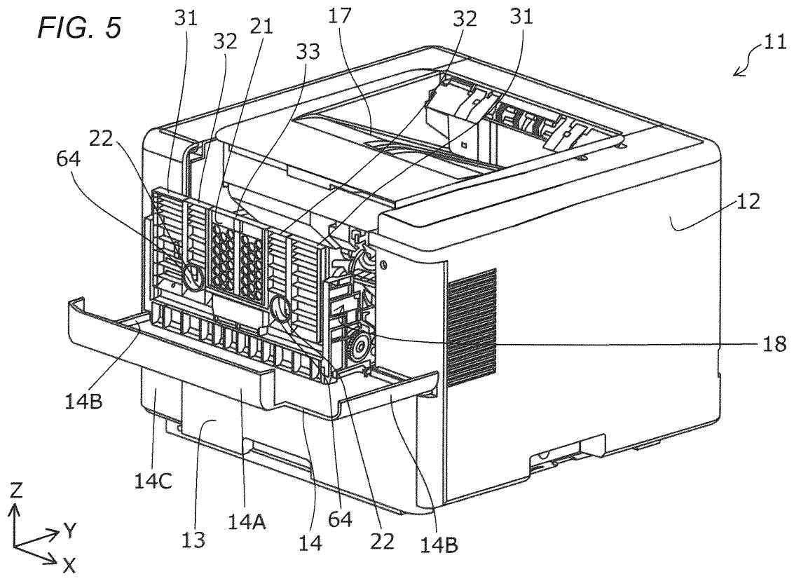

The flipping path unit 20 is configured to be detachably attached to the apparatus main body 12. As illustrated in FIG. 6, the recording apparatus 11 includes the medium conveyance apparatus 30. The medium conveyance apparatus 30 includes an apparatus main body 12 and the flipping path unit 20 that is detachably attached to the apparatus main body 12. As illustrated in FIGS. 4 and 5, the flipping path unit 20 includes operating portions 22 on a front surface. The flipping path unit 20 is locked to the apparatus main body 12 in the mounted state illustrated in FIG. 6 and so on. That is, the flipping path unit 20 is locked in the mounted state. The operating portions 22 are operated to attach and detach the flipping path unit 20 to and from the apparatus main body 12. The operating portions 22 are operated to unlock the flipping path unit 20 from the apparatus main body 12. As illustrated in FIG. 4, the flipping path unit 20 includes two operating portions 22.

The medium housing cassette 13 is disposed below the flipping path unit 20. The medium housing cassette 13 is configured to be drawable in the-Y direction from the rear surface toward the front surface of the apparatus main body 12. The medium housing cassette 13 is installed in the apparatus main body 12 by being moved in the +Y direction. The front cover 14 can take a first posture corresponding to a closed position illustrated in FIG. 1, a second posture corresponding to a first open position illustrated in FIG. 2, and a third posture corresponding to a second open position illustrated in FIG. 4. As illustrated in FIG. 4, in the third posture, the front cover 14 opens the opening portion 18 in a substantially horizontal state. The front cover 14 in the third posture is disposed below the flipping path unit 20.

Specifically, the inner surface of the front cover 14 includes a flat surface 14A having a width slightly larger than the width range of the flipping path unit 20 in the width direction (X-axis direction). At least the flat surface 14A in the inner surface of the front cover 14 in the third posture is disposed below the flipping path unit 20. Further, the front cover 14 has two extending portions 14B extending perpendicularly to the flat surface 14A at both sides across the flat surface 14A in the X-axis direction. Further, the front cover 14 has an extending portion 14C extending perpendicularly to the flat surface 14A at an opposite end portion of the flat surface 14A to the pivot shaft 19.

The front cover 14 can be opened and closed by pivoting about the pivot shaft 19. Although described later in detail, the movement of the front cover 14 in the rotation direction is restricted in each of the first posture illustrated in FIG. 1, the second posture illustrated in FIG. 2, and the third posture illustrated in FIG. 4. Here, in the medium conveyance apparatus 30 of the present embodiment, the flipping path unit 20 is detachably attached to the apparatus main body 12. By detaching the flipping path unit 20 from the apparatus main body 12, when a jam or the like occurs in a conveyance path T of the medium M, the medium M in which the jam has occurred can easily be removed.

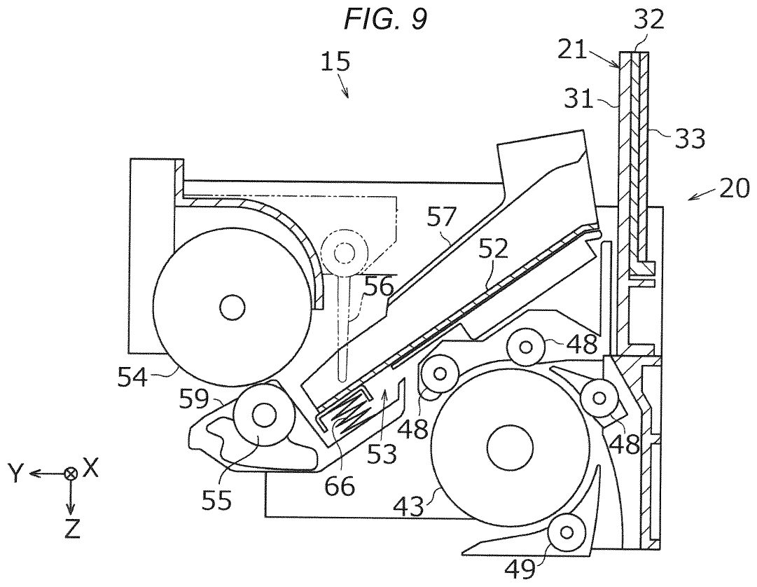

In the medium conveyance apparatus 30 of the present embodiment, when the front cover 14 is disposed in the third posture, the flipping path unit 20 can be attached and detached. In the state in which the lock to the apparatus main body 12 is released, the flipping path unit 20 is configured to be detachable along a path passing above the front cover 14 disposed in the third posture. As illustrated in FIG. 5, the flipping path unit 20 attached to the front portion of the apparatus main body 12 is configured to be drawable in the-Y direction. Note that the flipping path unit 20 pulled out from the apparatus main body 12 has a configuration illustrated in FIG. 9. The flipping path unit 20 can be pulled out in the-Y direction through a passage passing on the flat surface 14A while being guided in the X-axis direction by the pair of extending portions 14B at the left and right sides.

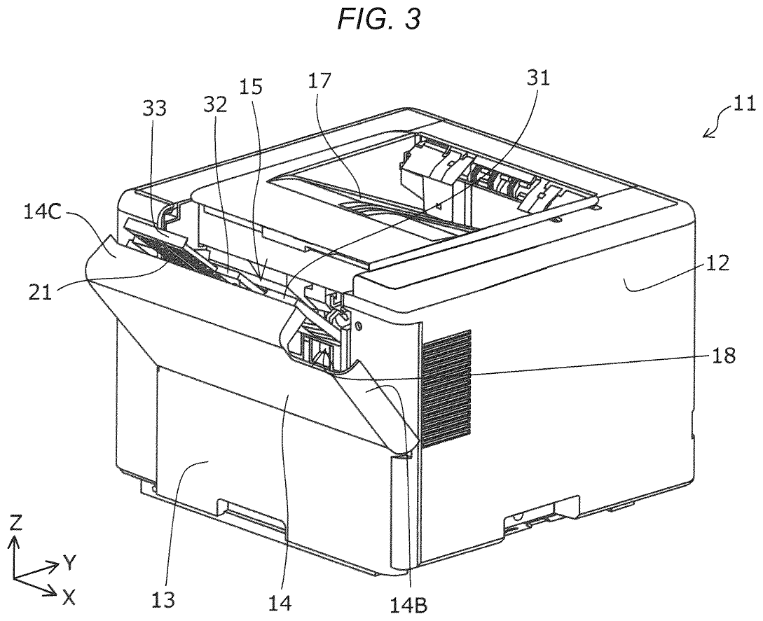

As illustrated in FIGS. 2 and 3, the support tray 21 includes a first tray 31, a second tray 32, and a third tray 33. The second tray 32 is configured to be switchable between a pulled-out state in which the second tray 32 is pulled out from the first tray 31 and a stored state in which the second tray 32 is stored in the first tray 31. Further, the third tray 33 is configured to be switchable between a pulled-out state in which the third tray 33 is pulled out from the second tray 32 and a stored state in which the third tray 33 is stored in the second tray 32. That is, the support tray 21 includes the three trays 31 to 33 slidably coupled to each other. In a state in which the support tray 21 is used, which is illustrated in FIG. 3, that is, a state in which the medium M can be set, for example, the three trays 31 to 33 are used in a state of being pulled out.

As illustrated in FIG. 6, the recording apparatus 11 includes the medium conveyance apparatus 30 and a recording unit 25 that performs recording on the medium M conveyed by the medium conveyance apparatus 30. The recording apparatus 11 includes a conveyance unit 40 and the recording unit 25 in the apparatus main body 12. The conveyance unit 40 conveys the medium M. Note that the flipping path unit 20 includes a part of the medium supply unit 15 and a part of the conveyance unit 40. Further, the recording apparatus 11 includes a controller 100. The controller 100 controls drive of each of the component members of the recording apparatus 11.

As illustrated in FIG. 6, the conveyance unit 40 conveys the medium M along paths TP, RP, FP1, and FP2. The conveyance path T of the medium M includes a first feed path FP1, a second feed path FP2, a main conveyance path TP, and a flipping path RP. In FIG. 4, the main conveyance path TP is indicated by a thick line. The main conveyance path TP is a path along which the conveyance unit 40 conveys the medium M from the medium housing cassette 13. The main conveyance path TP includes the first feed path FP1. The first feed path FP1 is a path through which the medium M is supplied from the medium housing cassette 13.

Further, in FIG. 6, the flipping path RP is indicated by a thick broken line. The flipping path RP is a path for flipping the medium M recording on a first surface (obverse surface) of which has been completed when double-side recording is performed. Further, in FIG. 6, the second feed path FP2 is indicated by a dashed-two dotted line. The second feed path FP2 is a path through which the medium supply unit 15 supplies the medium M supported by the support tray 21. The second feed path FP2 joins the main conveyance path TP at a position upstream in the conveyance direction A of a recording position of the recording unit 25. Note that a direction in which the medium M is conveyed toward the discharge port 16 along the main conveyance path TP is hereinafter referred to as a first conveyance direction A1. Further, a direction in which the medium M is conveyed along the flipping path RP is referred to as a second conveyance direction A2.

The medium housing cassette 13 includes a mounting plate 35 on which the medium M can be mounted. On the mounting plate 35, a plurality of media M can be mounted in a stacked state. The medium housing cassette 13 includes an edge guide portion 36 capable of positioning the plurality of media M mounted on the mounting plate 35. The mounting plate 35 is tiltably supported in a state of being biased upward. When the medium housing cassette 13 is installed in the apparatus main body 12, the mounting plate 35 is tilted upward by biasing force.

The conveyance unit 40 includes a plurality of rollers disposed along the main conveyance path TP. Specifically, the conveyance unit 40 includes a first feed roller 41, a separation roller pair 42, a flipping roller 43, a conveyance roller pair 44, a discharge roller pair 45, and a discharge roller 46. Further, the conveyance unit 40 includes a conveyance roller 47 that conveys the medium M along the flipping path RP. Further, the conveyance unit 40 includes a plurality of guide rollers 48, 49 disposed along an outer circumference of the flipping roller 43. The guide rollers 48, 49 are driven rollers. Further, the conveyance unit 40 includes a plurality of guide rollers 50 that guides the medium M along the main conveyance path TP.

The first feed roller 41 is disposed above a downstream end portion in the medium supply direction of the medium housing cassette 13. The uppermost one of the plurality of media M stacked on the mounting plate 35 in the medium housing cassette 13 comes into contact with the first feed roller 41. When the first feed roller 41 rotates, the uppermost medium M is fed from the medium housing cassette 13. The separation roller pair 42 is disposed at a position downstream in the feeding direction of the first feed roller 41. The separation roller pair 42 separates the media M fed from the first feed roller 41 into a single sheet. Accordingly, duplex feed of the media M is suppressed.

The flipping roller 43 is disposed at a position downstream in the feeding direction of the separation roller pair 42. The flipping roller 43 is a roller larger in diameter than the first feed roller 41. A plurality of guide rollers 48 is disposed along the outer circumferential surface of the flipping roller 43. The plurality of guide rollers 48 is driven to rotate by the rotation of the flipping roller 43 while nipping the medium M with the outer circumferential surface of the flipping roller 43. The flipping roller 43 rotates counterclockwise in FIG. 6. The medium M is conveyed in a path along the outer circumference of the flipping roller 43 in a state of being nipped between the flipping roller 43 and the plurality of guide rollers 48. Accordingly, the conveyance direction A of the medium M is changed to a substantially opposite direction to the feeding direction from the medium housing cassette 13 while the medium M is flipped. The medium M fed from the flipping roller 43 is conveyed downstream in the conveyance direction A toward the recording position of the recording unit 25.

The recording unit 25 performs recording on the medium M. The recording unit 25 performs recording on the medium M at the recording position on the main conveyance path TP. The recording unit 25 is disposed at a position facing the main conveyance path TP from above. The recording unit 25 includes a recording head 26 that performs recording on the medium M. The recording head 26 may be a line recording type line head having a length corresponding to the maximum width of the medium M, or may be of a serial recording type. In the serial recording type, recording is performed on the medium M by alternately performing a conveyance operation in which the conveyance unit 40 conveys the medium M to a subsequent recording position and a recording operation in which the recording unit 25 performs recording corresponding to one line (one pass) on the medium M while moving in the X-axis direction (scanning direction).

A support portion 27 is disposed at a position facing the recording unit 25 across the main conveyance path TP. The recording head 26 performs recording on the medium M supported by the support portion 27. The support portion 27 supports a portion located at the recording position out of the medium M. The recording unit 25 performs recording on a portion supported by the support portion 27 out of the medium M.

The medium supply unit 15 supplies the medium M supported by the support tray 21. The medium supply unit 15 includes a mounting portion 52, a hopper section 53, a supply roller 54, a separation roller 55, a medium detector 56, and an edge guide 57. The mounting portion 52 is disposed in a portion between the support tray 21 and the supply roller 54. The medium M supported by the support tray 21 is mounted on the mounting portion 52. A downstream portion in the supply direction in the medium M supported by the support tray 21 is mounted on the mounting portion 52. The mounting portion 52 is disposed in a posture inclined at an inclination angle according to an inclination angle when using the support tray 21. The mounting portion 52 is tiltably supported taking an upper end side as a fulcrum. In addition, the edge guide 57 is operated when positioning the medium M mounted on the mounting portion 52 in the X-axis direction.

The hopper section 53 is disposed below the mounting portion 52. The hopper section 53 switches the inclination angle of the mounting portion 52. The hopper section 53 has a function of pushing up the mounting portion 52 from a standby position illustrated in FIG. 6 to a feeding position when feeding the medium M. The hopper section 53 is driven via a cam (not illustrated) by power of a supply motor (not illustrated) which is a driving source of the supply roller 54. When the supply roller 54 starts rotating, the lock of the mounting portion 52 at the standby position is released by the cam. The mounting portion 52 moves from the standby position to the feeding position by biasing force of a spring 66 constituting the hopper section 53. The medium M on the mounting portion 52 having moved to the feeding position is pressed against the supply roller 54.

In this state, the supply roller 54 rotates in the clockwise direction in FIG. 6. The supply roller 54 and the separation roller 55 rotate while nipping the uppermost medium M supported by the support tray 21 to thereby supply the media M one by one. The separation roller 55 separates the media M supplied by the supply roller 54 into a single sheet.

Before the supply roller 54 finishes to make one revolution, a leading end portion of the medium M fed along the second feed path FP2 reaches a position where the leading end portion is nipped by the conveyance roller pair 44. When the supply roller 54 finishes to make one revolution, the mounting portion 52 returns from the feeding position to the standby position via the cam. The media M to be fed next time and subsequent times and placed on the mounting portion 52 are separated from the supply roller 54. In this way, the media M on the mounting portion 52 are fed one by one by the rotation of the supply roller 54 and the drive of the hopper section 53 in conjunction with the rotation of the supply roller 54. The conveyance roller pair 44 conveys the medium M thus nipped downstream in the conveyance direction A toward the recording position of the recording unit 25.

Note that the medium detector 56 detects the presence or absence of the medium M on the mounting portion 52. When the controller 100 receives a recording execution instruction, the controller 100 drives the supply motor to thereby rotate the supply roller 54 when the medium M on the mounting portion 52 is detected by the medium detector 56 at that time. The controller 100 does not rotate the supply roller 54 unless the medium M on the mounting portion 52 is detected by the medium detector 56.

Then, convey of the medium M and recording on the medium M in the recording apparatus 11 will be described. Hereinafter, single-side recording and double-side recording will be described in order. First, the single-side recording will be described. The medium M is conveyed along the main conveyance path TP from the medium housing cassette 13. The recording unit 25 performs recording on the medium M at the recording position in the middle of the main conveyance path TP. The medium M on which recording has been performed is conveyed along the main conveyance path TP from the recording position and is then discharged from the discharge port 16. The medium M on which recording has been performed and which has been discharged from the discharge port 16 is stacked on the stacker 17. In contrast, when the medium M is fed from the medium supply unit 15, the medium M supported by the support tray 21 is fed by the supply roller 54. The medium M fed along the second feed path FP2 reaches the main conveyance path TP. Subsequently, after the recording unit 25 performs recording on the medium M at the recording position on the main conveyance path TP, the medium M on which recording has been performed is discharged from the discharge port 16. The medium M on which recording has been performed and which has been discharged is stacked on the stacker 17.

Then, the double-side recording will be described. When the double-side recording is performed, recording on a first surface of the medium M is performed in substantially the same manner as in the case of the single-side recording described above. The controller 100 switches the conveyance direction to the opposite direction by reversing the discharge roller 46 during discharging, from the discharge port 16, the medium M recording on the first surface of which has been performed. Specifically, the controller 100 recognizes the position of the medium M on the main conveyance path TP. The controller 100 recognizes the position of the medium M on the main conveyance path TP based on a detection result of the sensor that detects the medium M at a predetermined position on the main conveyance path TP and a conveyance amount of the medium M from the position thus detected. The controller 100 switches the conveyance direction of the medium M to the opposite direction when a trailing end of the medium M on which recording has been performed passes a branch position between the main conveyance path TP and the flipping path RP downstream in the conveyance direction A.

The recording apparatus 11 includes a flap 38 at a branch portion between the main conveyance path TP and the flipping path RP. The flap 38 is capable of selecting the path of the medium M at the branch position. The flap 38 guides, to the flipping path RP, the medium M that is reversely conveyed in the opposite direction to the first conveyance direction A1. The flipping path RP is disposed as a path passing below the main conveyance path TP. The flipping path RP is a path for conveying the medium M in the second conveyance direction A2 from the branch position to an entrance to the flipping roller 43. The medium M guided to the flipping path RP is sent to a position where the trailing end thereof passes through the conveyance roller 47 due to the rotation of the discharge roller 46. The medium M the leading end of which has been separated from the discharge roller 46 is conveyed in the second conveyance direction A2 along the flipping path RP due to the rotation of the conveyance roller 47.

When the trailing end of the medium M conveyed along the flipping path RP reaches the entrance of the flipping roller 43, the trailing end of the medium M is nipped by the flipping roller 43 and the guide roller 49. By the flipping roller 43 rotating in this state, the medium M is conveyed along the path on the outer circumference of the flipping roller while merging with the first feed path FP1. In this way, the medium M recording on the first surface of which is completed is flipped. The medium M thus flipped is conveyed in the first conveyance direction A1 along the main conveyance path TP. The recording unit 25 performs recording on a second surface of the medium M at the recording position in the middle of the main conveyance path TP. In this way, recording is performed on both surfaces of the medium M. The medium M recording on both surfaces of which has been performed is conveyed along the main conveyance path TP and is then discharged from the discharge port 16. The medium M on which double-side recording has been performed and which has been discharged is stacked on the stacker 17.

As described above, the medium conveyance apparatus 30 constituting the recording apparatus 11 according to the present embodiment includes the apparatus main body 12, the medium housing cassette 13 configured to be drawable in the pull-out direction corresponding to the-Y direction with respect to the apparatus main body 12, and the flipping path unit 20 as a conveyance unit including a part of the conveyance path T for conveying the medium M housed in the medium housing cassette 13. Further, the recording apparatus 11 includes the support tray 21 that is provided integrally with the flipping path unit 20 and is capable of supporting the medium M, and the front cover 14 that is provided to be capable of covering the opening portion 18 disposed downstream in the pull-out direction of the flipping path unit 20 in the apparatus main body 12 and is capable of opening and closing taking the X-axis direction crossing the pull-out direction as an extending direction of the pivot shaft 19.

Here, the front cover 14 will hereinafter be described in detail. The front cover 14 can take the first posture for covering the opening portion 18 illustrated in FIG. 1. In addition, the front cover 14 can take the second posture in which the extending portion 14C as a rotation tip at an opposite side to the pivot shaft 19 is located more downstream in the pull-out direction than in the first posture as illustrated in FIGS. 2 and 3, and which makes it possible to feed the medium M from the support tray 21. In addition, the front cover 14 can take a third posture in which the rotation tip (the extending portion 14C) is located more downstream in the pull-out direction than in the second posture as illustrated in FIGS. 4 and 5, and in which the flipping path unit 20 can be attached to and detached from the apparatus main body 12.

That is, the front cover 14 in the present embodiment can take the second posture in which a degree of opening takes a value between those in the first posture and the third posture in addition to the first posture of covering the opening portion 18 and the third posture in which the flipping path unit 20 can be attached to and detached from the apparatus main body 12. Therefore, the recording apparatus 11 of the present embodiment can variously change the degree of opening of the front cover 14 in accordance with the content of the operation, and can improve the workability of each operation.

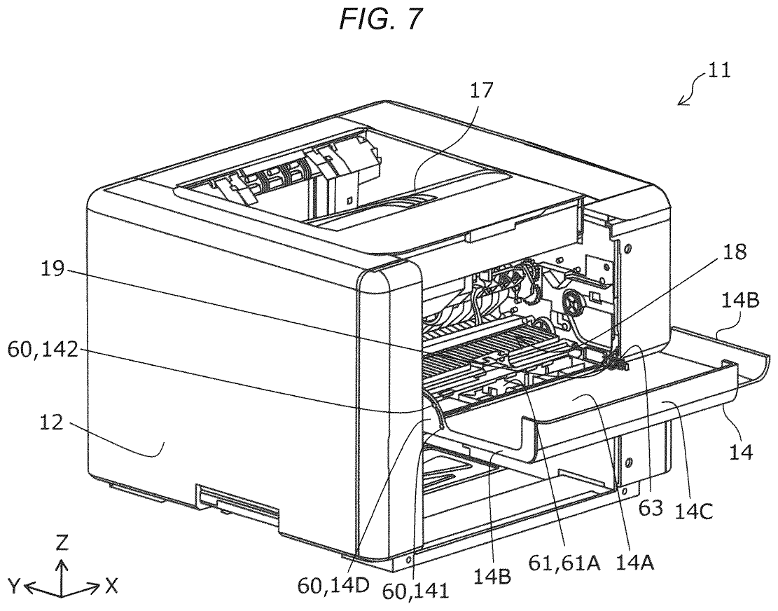

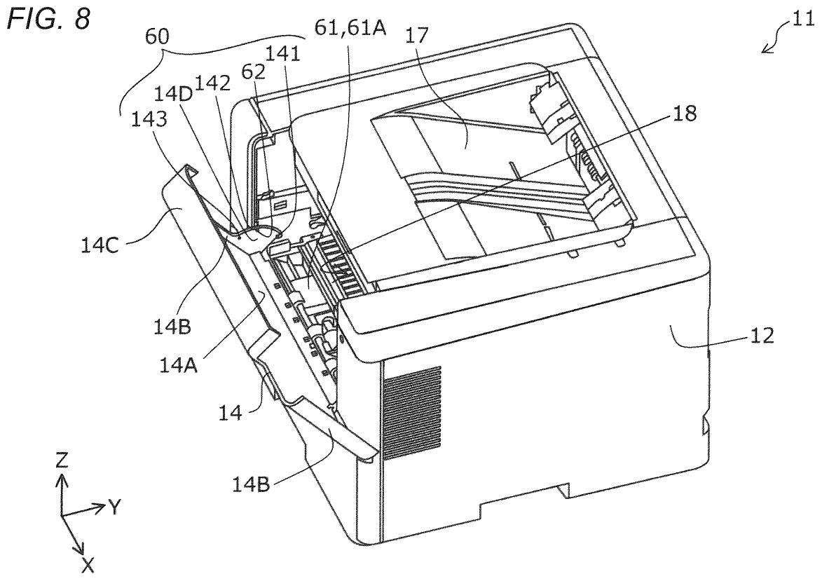

Note that FIG. 7 illustrates a state in which the flipping path unit 20 is further pulled out from the state in FIG. 5 in a state in which the front cover 14 is set in the third posture, and the flipping path unit 20 is detached from the apparatus main body 12. In the recording apparatus 11 according to the present embodiment, even after the flipping path unit 20 is detached from the apparatus main body 12, the front cover 14 can be set in the second posture as illustrated in FIG. 8, and the front cover 14 can be set in the first posture. FIG. 9 illustrates the flipping path unit 20 detached from the apparatus main body 12.

In the description from the viewpoint of the liquid ejection apparatus, the recording apparatus 11 as the liquid ejection apparatus of the present embodiment includes the recording unit 25 as a liquid ejection unit that ejects ink as a liquid to form an image, and the medium conveyance apparatus described above. Therefore, the recording apparatus 11 of the present embodiment can improve the workability of each operation in the liquid ejection apparatus capable of forming an image and so on by ejecting the liquid onto the medium M.

Here, the conveyance unit in the recording apparatus 11 according to the present embodiment is the flipping path unit 20 which configures at least a part of the flipping path RP which flips the medium M in the conveyance path T. Since the recording apparatus 11 of the present embodiment has such a configuration, for example, when a jam or the like of the medium M occurs in the flipping path RP and so on, it is possible to easily remove the medium M in which the jam occurs.

In addition, as illustrated in FIG. 9, in the recording apparatus 11 of the present embodiment, the flipping path unit 20 includes the mounting portion 52 on which the medium M supported by the support tray 21 is mounted, and the hopper section 53 capable of switching the inclination angle of the mounting portion 52 when viewed from the X-axis direction in which the pivot shaft 19 extends. Since the recording apparatus 11 of the present embodiment has such a configuration, the recording apparatus 11 can preferably convey the medium M supported by the support tray 21.

In addition, as illustrated in FIG. 9, the recording apparatus 11 of the present embodiment includes the separation roller 55 in the flipping path unit 20. The separation roller 55 is a separation roller that separates the media M supported by the support tray 21. By adopting a configuration in which the separation roller 55 is provided as in the recording apparatus 11 of the present embodiment, it is possible to convey the medium M supported by the support tray 21 while suppressing occurrence of duplex feed or the like.

In addition, as illustrated in FIG. 9, the recording apparatus 11 of the present embodiment includes the supply roller 54 in the flipping path unit 20. The supply roller 54 is a roller for supplying the medium M supported by the support tray 21 to the main conveyance path TP. By adopting a configuration including the supply roller 54 as in the recording apparatus 11 of the present embodiment, it is possible to suitably convey the medium M supported by the support tray 21.

Here, a posture maintaining section 60 that changes and maintains the front cover 14 in the first posture, the second posture, and the third posture will be described. As illustrated in FIGS. 7, 8, 10, and 11, the posture maintaining section 60 includes holes 141, 142, and 143 formed in a fan-shaped portion 14D provided to the extending portion 14B at the-X direction side of the front cover 14, and a protrusion 62 disposed at a position facing the fan-shaped portion 14D in the X-axis direction in the opening portion 18 of the apparatus main body 12. As described above, the recording apparatus 11 according to the present embodiment includes the posture maintaining section 60 having the three holes 141, 142, and 143 provided to the front cover 14 and the protrusion 62 provided to the apparatus main body 12.

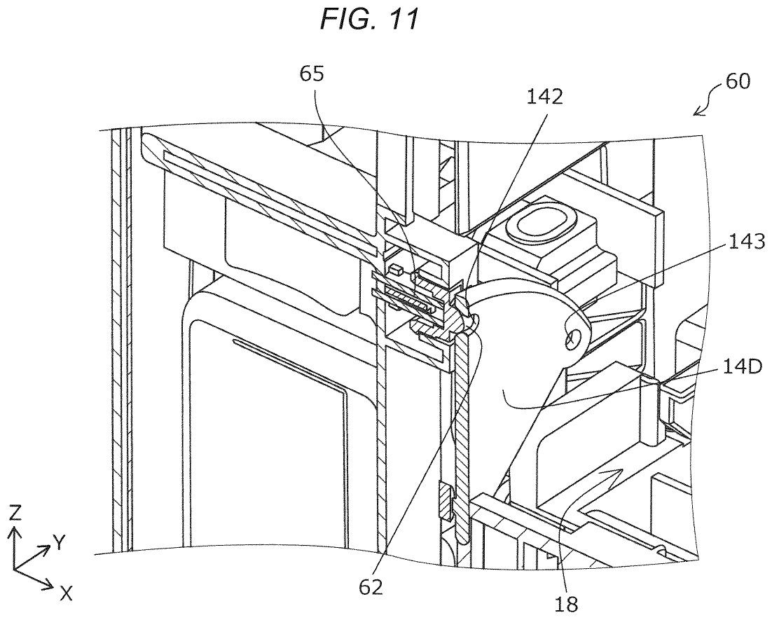

As described above, it is preferable to provide the posture maintaining section 60 of the front cover 14 having a protrusion provided to one of the front cover 14 and the opening portion 18 and a hole that is provided to the other of the front cover 14 and the opening portion 18 and is engaged with the protrusion. Further, it is preferable to adopt a configuration in which the front cover 14 can be maintained in at least three postures of the first posture, the second posture, and the third posture by having at least one of three protrusions and three holes as in the posture maintaining section 60 in the present embodiment. Note that as illustrated in FIG. 11, the posture maintaining section 60 in the present embodiment includes a compression spring 65 that presses the protrusion 62 in the +X direction. Since such a configuration is adopted, the protrusion 62 is easily fitted into the holes 141, 142, and 143. Note that the pressing force of the compression spring 65 that presses the protrusion 62 in the +X direction corresponds to locking force of the posture maintaining section 60.

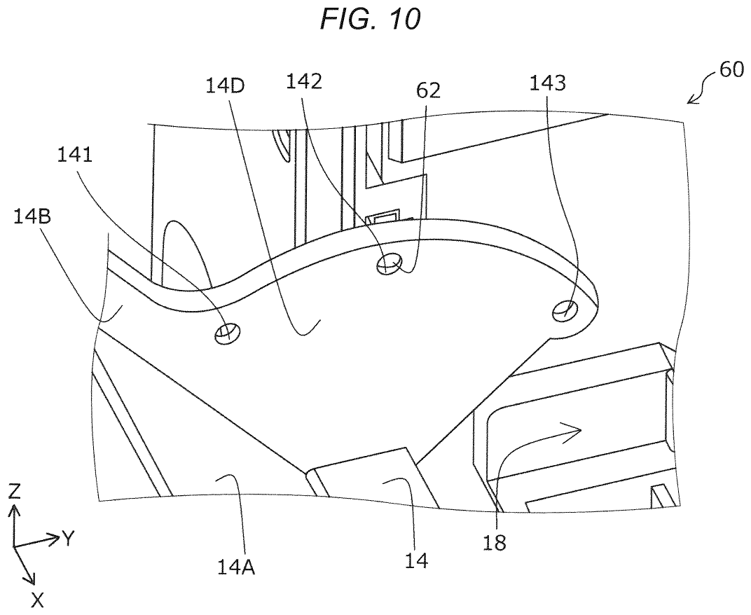

This is because by adopting such a configuration, the front cover 14 can be maintained in at least three postures of the first posture, the second posture, and the third posture with a simple device configuration. Note that FIGS. 10 and 11 illustrate a state in which the protrusion 62 is fitted into the hole 142 out of the three holes 141, 142, and 143 to maintain the front cover 14 in the second posture, and FIG. 7 illustrates a state in which the protrusion 62 is fitted into the hole 143 to maintain the front cover 14 in the third posture. When the protrusion 62 is fitted into the hole 141, the front cover 14 is maintained in the first posture.

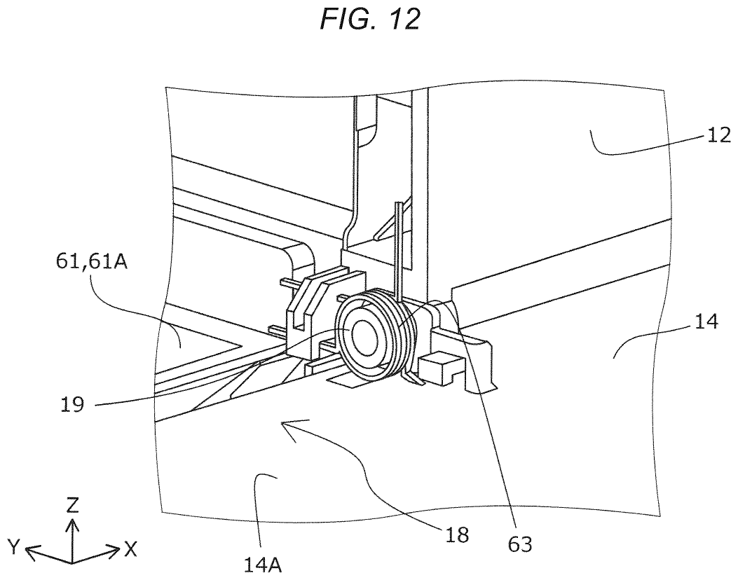

In addition, as illustrated in FIGS. 7 and 12, the recording apparatus 11 of the present embodiment includes a torsion spring 63 which is provided so as to be fitted to the pivot shaft 19 of the front cover 14. The torsion spring 63 serves as a biasing portion that urges the front cover 14 in a closing direction opposite to an opening direction in which the front cover 14 is rotated by gravity. Since the recording apparatus 11 according to the present embodiment adopts such a configuration, the recording apparatus 11 can suitably rotate the front cover 14 in both of rotating the front cover 14 in the opening direction in which the front cover 14 rotates by gravity and rotating the front cover 14 in the closing direction opposite to the rotation direction in which the front cover 14 rotates by gravity. Further, by adopting such a configuration, it is possible to reduce the locking force (pressing force of the compression spring 65) between the protrusion 62 and the holes 141, 142, and 143 in the posture maintaining section 60.

In addition, as illustrated in FIGS. 7 and 12, the recording apparatus 11 of the present embodiment includes the support portion 61 that supports the flipping path unit 20 with a support surface 61A in the apparatus main body 12, and the front cover 14 has a configuration in which the flat surface 14A maintains the posture without a step with respect to the support surface 61A in the third posture. Since the recording apparatus 11 of the present embodiment has such a configuration, it is possible to smoothly attach and detach the flipping path unit 20 to and from the apparatus main body 12.

Further, as described above, the recording apparatus 11 according to the present embodiment includes the operating portions 22 that are operated when the flipping path unit 20 is attached to and detached from the apparatus main body 12. Here, as illustrated in FIGS. 4 and 5, the support tray 21 is provided with through holes 64 that enable access to the operating portions 22. Further, the front cover 14 in the present embodiment includes the extending portion 14C as described above, and as illustrated in FIG. 1, the extending portion 14C serves as a crossing-direction cover portion that covers a part of the apparatus main body 12 in the Y-axis direction corresponding to the pull-out direction and the X-axis direction corresponding to the direction in which the pivot shaft 19 extends and the Z-axis direction that is a crossing-direction crossing the Y-axis direction and the X-axis direction when the front cover 14 is in the first posture. Here, as illustrated in FIGS. 4 and 5, the extending portion 14C as the crossing-direction cover portion is disposed at a position that does not overlap the through holes 64 when viewed in the Y-axis direction along the pull-out direction when the front cover 14 is in the third posture.

Since the recording apparatus 11 of the present embodiment has such a configuration, it is possible to particularly suitably cover the opening portion 18, and access to the operating portions 22 is not hindered. Further, in addition to these, when the flipping path unit 20 is pulled out, it is possible to prevent the flipping path unit 20 from being pulled out to the-Y direction side beyond the extending portion 14C, to prevent the flipping path unit 20 from being pulled out more than necessary to be dropped.

The present disclosure is not limited to the embodiment and modified examples described above, but various modifications can be made within the scope of the disclosure set forth in the appended claims, and it is obvious that these modifications also fall within the scope of the present disclosure. For example, in the posture maintaining section 60 in the present embodiment, the front cover 14 can be maintained in the three postures of the first posture, the second posture, and the third posture by providing the three holes to be fitted to the protrusion, but it is possible to adopt a configuration in which four or more of at least one of protrusions and holes are provided to make it possible to maintain the front cover 14 in four or more postures.

What is claimed is:

1. A medium conveyance apparatus comprising:
an apparatus main body;
a medium housing cassette configured to be pulled out in a pull-out direction with respect to the apparatus main body;
a conveyance unit including a part of a conveyance path through which a medium housed in the medium housing cassette is conveyed;
a support tray provided integrally with the conveyance unit and configured to support media; and
a cover provided so as to cover an opening portion disposed downstream in the pull-out direction of the conveyance unit in the apparatus main body, and configured to be opened and closed setting a direction crossing the pull-out direction as an extending direction of a pivot shaft, wherein
the cover takes a first posture of covering the opening portion, a second posture in which a rotation tip at an opposite side to the pivot shaft is located more downstream in the pull-out direction than in the first posture and in which feeding of the medium from the support tray is enabled, and a third posture in which the rotation tip is located more downstream in the pull-out direction than in the second posture and in which the conveyance unit is attachable to and detachable from the apparatus main body.

2. The medium conveyance apparatus according to claim 1, wherein
the conveyance unit is a flipping path unit forming at least a part of a flipping path configured to flip the medium in the conveyance path.

3. The medium conveyance apparatus according to claim 1, wherein
the conveyance unit includes a mounting portion on which the medium supported by the support tray is mounted, and a hopper section configured to switch an inclination angle of the mounting portion viewed from a direction in which the pivot shaft extends.

4. The medium conveyance apparatus according to claim 1, wherein
the conveyance unit includes a separation roller configured to separate the media supported by the support tray.

5. The medium conveyance apparatus according to claim 1, wherein
the conveyance unit includes a supply roller configured to supply the medium supported by the support tray.

6. The medium conveyance apparatus according to claim 1, further comprising
a posture maintaining section of the cover, the posture maintaining section including a protrusion provided to one of the cover and the opening portion, and a hole provided to another of the cover and the opening portion and configured to be engaged with the protrusion, wherein
the posture maintaining section is configured to maintain the cover in at least three postures of the first posture, the second posture, and the third posture by including at least one of three protrusions each identical to the protrusion and three holes each identical to the hole.

7. The medium conveyance apparatus according to claim 1, further comprising
a biasing portion configured to bias the cover in an opposite direction to a rotation direction in which the cover rotates by gravity.

8. The medium conveyance apparatus according to claim 1, further comprising
a support portion configured to support the conveyance unit with a support surface in the apparatus main body, wherein
in the third posture, a posture of the cover is maintained without a step from the support surface.

9. The medium conveyance apparatus according to claim 1, further comprising:
an operating portion configured to be operated when the conveyance unit is attached to and detached from the apparatus main body;
a through hole provided to the support tray and configured to enable access to the operating portion; and
a crossing-direction cover portion provided to the cover and configured to cover a part of the apparatus main body in the pull-out direction, a direction in which the pivot shaft extends, and a crossing-direction crossing the pull-out direction and the direction in which the pivot shaft extends when the cover is in the first posture, wherein
the crossing-direction cover portion is disposed at a position not overlapping the through hole when viewed from a direction along the pull-out direction when the cover is in the third posture.

10. A liquid ejection apparatus comprising:
a liquid ejection unit configured to eject a liquid; and
the medium conveyance apparatus according to claim 1.
